(19) United States
(12) Patent Application Publication
(10) Pub. No.: US 2024/0202521 A1
(43) Pub. Date: Jun. 20, 2024

(54) ARTIFICIAL NEURAL NETWORK TRAINING USING EDGE DEVICES

(71) Applicant: Micron Technology, Inc., Boise, ID (US)

(72) Inventors: Pavana Prakash, Houston, TX (US); Shashank Bangalore Lakshman, Folsom, CA (US); Febin Sunny, Folsom, CA (US); Saideep Tiku, Fort Collins, CO (US); Poorna Kale, Folsom, CA (US)

(21) Appl. No.: 18/535,926

(22) Filed: Dec. 11, 2023

Related U.S. Application Data
(60) Provisional application No. 63/433,645, filed on Dec. 19, 2022.

(51) Int. Cl. G06N 3/08

(52) U.S. Cl. CPC G06N 3/08

(57) ABSTRACT

Training the ANN can include providing an initial ANN model to a plurality of groups of edge devices and providing an input to a group of edge devices from the plurality of groups of edge devices. Training the ANN can also include, responsive to providing the input, receiving activation signals from a first portion of the plurality of groups. Training the ANN can include providing the activation signals to a second portion of the plurality of groups and provide commands to the plurality of groups of edge devices to train the initial ANN model to generate a trained ANN model based on training feedback generated using different activation signals received from the second portion of the plurality of groups. Training the ANN can also include receiving the trained ANN model from the plurality of groups of edge devices.

### PRIORITY INFORMATION

This application claims the benefit of U.S. Provisional Application No. 63/433,645, filed on Dec. 19, 2022, the contents of which are incorporated herein by reference.

### TECHNICAL FIELD

The present disclosure relates generally to apparatuses, non-transitory machine-readable media, and methods associated with training artificial neural networks using edge devices.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Computing devices can be used to implement artificial neural networks (ANNs). Computing devices can also be used to train the ANNs.

### BRIEF DESCRIPTION OF THE DRAWINGS

FIG. 1 illustrates example computing systems for training an artificial neural network model in accordance with some embodiments of the present disclosure.

FIG. 2 illustrates a block diagram for training an initial artificial neural network model in accordance with some embodiments of the present disclosure.

FIG. 3 illustrates a block diagram for training an artificial neural network model in accordance with some embodiments of the present disclosure.

FIG. 4 is a flow diagram corresponding to a method for training an initial artificial neural network model in accordance with some embodiments of the present disclosure.

FIG. 5 is a block diagram of an example computer system in which embodiments of the present disclosure may operate.

### DETAILED DESCRIPTION

Apparatuses, machine-readable media, and methods related to training an artificial neural network (ANN) are described. In various instances, an ANN can be trained by providing an initial ANN model to a plurality of groups of edge devices from a central server. An input can also be provided to a group of edge devices from the plurality of groups of mobile devices. The central server can receive activation signals from a first portion of the plurality of groups of the edge devices. The central server can provide the activation signals to a second portion of the plurality of groups. The central server can also provide commands to the plurality of groups of mobile devices to train the initial ANN model to generate a trained ANN model based on training feedback generated using the activation signals. The central server can receive the trained ANN model from the plurality of groups of edge devices.

As used herein, the ANN can provide learning by forming probability weight associations between an input and an output. The probability weight associations can be provided by a plurality of nodes that comprise the ANN. The nodes together with weights, biases, and/or activation functions can be used to generate an output of the ANN based on the input to the ANN. A plurality of nodes of the ANN can be grouped to form layers of the ANN.

Artificial intelligence (AI) accelerators such as deep learning accelerators (DLAs) can be utilized to train ANNs. As used herein, AI refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. However, training ANNs using an AI accelerator such as a DLA can be resource intensive. As the size of the ANNs grows, the resources required from the DLA can also increase. In various examples, processors are described for performing the examples described herein. AI accelerators can also be utilized to perform the examples described herein instead of or in concert with the processors.

ANN training can be performed using large server farms which provide the necessary compute and memory resources. However, the resources used to train large ANNs can limit the ability to train ANNs as the ANNs grow in size.

Aspects of the present disclosure address the above and other deficiencies by utilizing edge devices to train the ANNs. As used herein, an edge device describes a device that has processing capabilities and that connects and/or exchanges data with other devices and systems over a communications network. For example, edge devices can include internet of thing (IOT) devices and/or user equipment (UE). A UE can include hand-held devices such as a hand-held telephone and/or a laptop computer equipped with a mobile broadband adapter, among other possible devices. IOT devices can include devices that comprise sensors and which can exchange data collected from said sensors. IOT devices can include smart home devices such as thermostats and doorbells and/or wearable devices such as smart watches, among other possible IOT devices. Edge devices can also include drones, for example.

In various instances, edge devices can be utilized to implement federated learning. Federated learning describes the training of an algorithm using multiple decentralized edge devices. In various examples, each of the edge devices can receive a different portion of an ANN model. The edge devices can also receive a data set from a centralized server. The data set and the different portions of the ANN model can be utilized by the edge devices to train the ANN model.

The processing resources and/or memory resources of the edge devices can be repurposed and utilized to train the ANN model. To deploy the ANN model for training on edge devices, a task graph associated with the ANN model can be divided in such a way that edge devices are contractually obligated or monetarily incentivized to run a small part of the ANN model using their local computational resources. As used herein, a task graph is a graphical representation of forward propagation paths and/or backward propagation paths through which activation signals are passed between edge devices and can represent the processing operations performed by the edge devices in implementing a forward propagation of the ANN model and/or a backward propagation of the ANN model. A central server can divide a dataset into batches and can share the dataset with the edge devices. The edge devices can perform training using their local computational resources and the activations (e.g., activation signals) can be uploaded to the central server.

The central server can aggregate the received activation signals and can facilitate training in the other participating edge devices by sharing these activation signals. The next set of edge devices can perform their local training using these activation signals and can share their computed activation signals with the central server, which can aggregate the newly received activation signals. This continues until the task graph is completed through training on edge devices and sharing the activation signals with the central server. The forward propagation of the ANN model using the edge devices and a batch of data can be described as a loop (e.g., training loop). At the end of the first loop, the central server can utilize the final activation values for driving backpropagation in the reverse order of the forward propagation. In order to boost the usage of edge device resources during training, once a participating edge device concludes training in a given training loop, the central server can initiate a next loop/batch of training on the edge device so that edge devices can work in parallel in different loops.

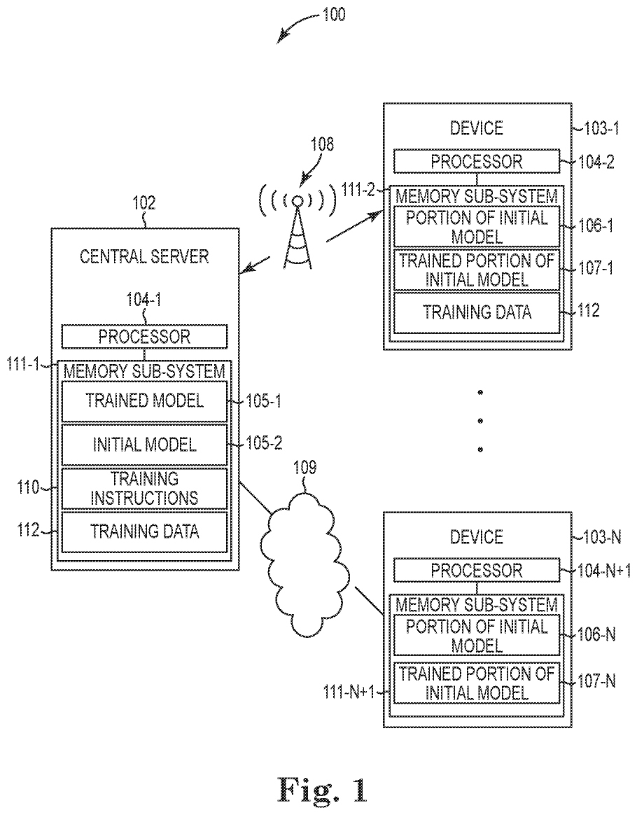

FIG. 1 illustrates example computing system 100 for training an initial ANN model in accordance with some embodiments of the present disclosure. The computing system 100 can comprise a central server 102 and edge devices 103-1, 103-N (e.g., devices 103-1, 103-N), referred to herein as edge devices 103.

The computing system 100, the central server 102, and the edge devices 103 can comprise hardware, firmware, and/or software configured to train an ANN model. As used herein, an ANN model can include a plurality of weights, biases, and/or activation functions among other variables that can be used to execute an ANN. The central server 102 and the edge devices 103 can further include memory sub-systems 111-1, 111-2, 111-N+1 (e.g., a non-transitory MRM), referred to herein as memory sub-system 111, on which may be stored instructions (e.g., training instructions 110) and/or data (e.g., training data 112, trained model 105-1, and/or initial model 105-2). Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory sub-systems 111 may comprise memory devices. The memory devices may be electronic, magnetic, optical, or other physical storage device that stores executable instructions. One or both of the memory devices may be, for example, non-volatile or volatile memory. In some examples, one or both of the memory device is a non-transitory MRM comprising RAM, an Electrically-Erasable Programmable ROM (EEPROM), a storage drive, an optical disc, and the like. The memory sub-systems 111 may be disposed within a controller, the central server 102, and/or the edge devices 103. In this example, the executable training instructions 110 (e.g., training instructions) can be “installed” on the central server 102. The memory sub-systems 111 can be portable, external or remote storage mediums, for example, that allow the central server 102 and/or the edge devices 103 to download the training instructions 110 from the portable/external/remote storage mediums. In this situation, the executable training instructions 110 may be part of an “installation package.” As described herein, the memory sub-systems 111 can be encoded with executable instructions for training an ANN.

The central server 102 can execute the trainning instructions 110 using the processor 104-1 also referred to herein as processing device 104-1. The training instructions 110 can be stored in the memory sub-system 111-1 prior to being executed by the processing device 104-1. The execution of the training instructions 110 can cause the initial model 105-2 (initial ANN model 105-2) to be provided to the edge devices 103.

For example, the central server 102 can divide the initial ANN model 105-2 into multiple portions 106-1, 106-N, referred to as portions 106. Each of the portions 106 of the initial ANN model 105-2 can correspond to a layer of the initial ANN model 105-2 or multiple layers of the initial ANN model 105-2. For example, the central server 102 can provide an input layer of the initial ANN model 105-2 to the edge device 103-1 and an output layer of the initial ANN model 105-2 to the edge device 103-N. The central server 102 can provide the portions 106 of the initial ANN model 105-2 and the training data 112 to the edge devices 103 utilizing a wireless network 108 and/or a physical network 109.

The edge devices 103 can store the portions 106 and the training data 112. The edge devices 103, comprising the processors 104-2, 104-N+1, can execute the portions 106 (e.g., initial ANN model portion) of the initial ANN model 105-2 utilizing the processors 104-2, 104-N+1 to generate activation signals. Although not shown, the activation signals can be stored in the memory sub-systems 111-2, 111-N+1 of the edge devices 103. The activation signals can be provided to the central server 102. The central server 102 can provide the activation signals to different edge devices from the edge devices 103 for further processing.

Eventually, the central server 102 can receive an output for the initial ANN model 105-2. The central server 102 can utilize the output to generate corrections (e.g., training feedback) for the initial ANN model 105-2. The corrections can be used to modify the weights, biases, and/or activation functions of the initial ANN model 105-2. The corrections can be provided to the edge devices 103. The edge devices 103 can affect the corrections to update the initial ANN model 105-2 to generate the trained ANN model 105-1 (e.g., trained model). As used herein, the trained ANN model 105-1 can describe an ANN model that has been trained using training data 112. Each of the edge devices 103 can update a corresponding portion (e.g., the portions 106 of the initial ANN model) of the initial ANN model 105-2 to generate a trained portions (e.g., trained portions 107 of the initial ANN model 105-2). The edge devices 103 can provide the trained ANN model 105-1 to the central server 102. The central server 102 can utilized the trained ANN model 105-1 and/or can provide the trained model 105-1 to a different computing device to utilize the trained ANN model 105-1.

The central server 102 can execute the training instructions 110, using the processor 104-1, to train the initial ANN model 105-2 and generate the trained ANN model 105-1. Although the training instructions 110 are shown as software in FIG. 1, the training instructions 110 can encoded in a computer readable-medium or be logic to train an ANN model (e.g., an initial ANN model 105-2).

For example, the central server 102 can execute the training instructions 110 to cause the initial ANN model 105-2 to be divided into the portions 106 and to be provided to the edge devices 103. The central server 102 can provide the portion 106-1 of the initial ANN model 105-2 to the edge device 103-1 and the portion 106-N of the initial ANN model 105-2 to the edge device 103-N. Each edge device from the edge devices 103 can receive a different portion 106 of the initial ANN model 105-2. In various instances, some of the edge devices 103 can receive a same portion 106 of the initial ANN model 105-2. For instance, a first edge device can receive a first portion while a second edge device and a third edge devices receive a second portion.

The edge devices 103 can provide activation signals generated using the portions 106 of the initial ANN model 105-2 to process previously received activation signals or to process the training data 112. For instance, the edge device 103-1 can process the training data 112 using the portion 106-1 of the initial ANN model 105-2 to generate a first plurality of activation signals. The edge device 103-1 can provide the first plurality of activation signals to the central server 102. The central server 102 can provide the activation signals to one or more different edge devices (not shown). The different edge devices can process the activation signals to generate additional activation signals. The different edge devices can provide, through the central server 102, the additional activation signals to additional edge devices. This processing of activation signals can continue until the edge device 103-N receives activation signals for processing. The edge device 103-N can process the activation signals to generate an output which is provided to the central server 102.

In various instances, the central server 102 can provide instructions to the edge devices 103 to cause the edge devices 103 to provide their activation signals to different edge devices 103 directly without first providing their activation signals to the central server 102. In this case, the central server 102 does not distribute activation signals but rather provides an input and receives and output from the edge devices 103.

In various examples, the processors 104 can be internal to the memory sub-systems 111 instead of being external to the memory sub-systems 111 as shown. For instance, the processors 104 can be processor in memory (PIM) processors. The processors 104 can be incorporated into the sensing circuitry of the memory sub-systems 111 and/or can be implemented in the periphery of the memory sub-system 111, for instance. The processors 104 can be implemented under one or more memory arrays of the memory sub-system 111.

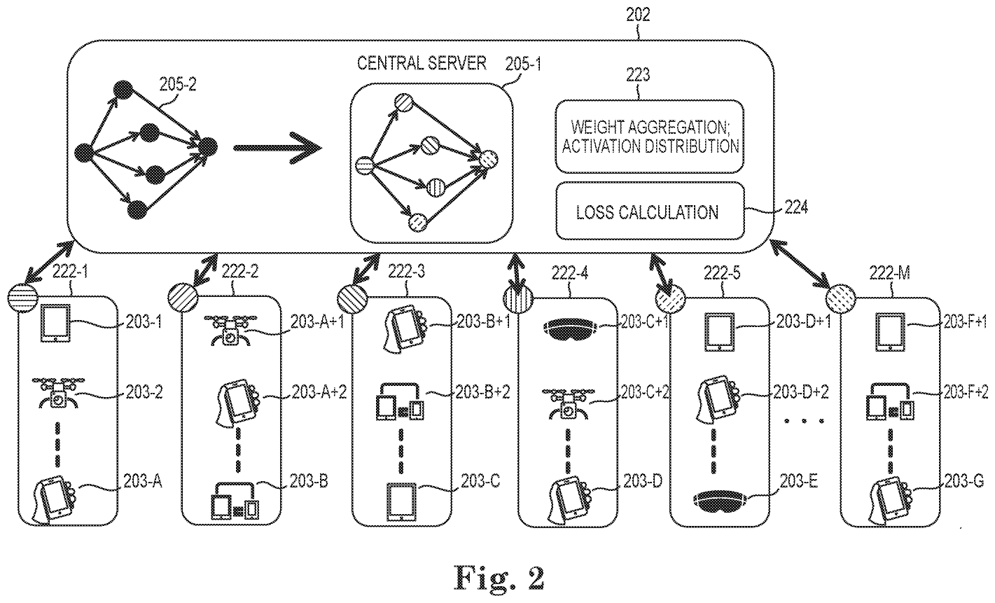

FIG. 2 illustrates a block diagram for training an initial ANN model 205-2 in accordance with some embodiments of the present disclosure. FIG. 2 includes a central server 202 and multiple groups 222-1, 222-2, 222-3, 222-4, 222-5, 222-M, referred to as groups 222, of edge devices 203-1, 203-2, 203-A, 203-A+1, 203-A+2, 203-B, 203-B+1, 203-B+2, 203-C, 203-C+1, 203-C+2, 203-D, 203-D+1, 203-D+2, 203-E, 203-F+1, 203-F+2, 203-G, referred to as edge devices 203. The central server 202 can store an initial ANN model 205-2 and a trained ANN model 205-1. The central server 202 can store instructions 223 for performing weight aggregation and activation signal distribution. The central server 202 can also store instructions 224 for performing loss calculations. In various instances the instructions 223 and 224 can be implemented as hardware and/or firmware. The instructions 223 and 224 can be executed by a processor 104-1 of FIG. 1.

Each of the groups 222 can comprise one or more edge devices 203. For example, the group 222-1 comprises edge devices 203-1, 203-2, 203-A. The group 222-2 comprises edge devices 203-A+1, 203-A+2, 203-B. The group 222-3 comprises edge devices 203-B+1, 203-B+2, 203-C. The group 222-4 comprises edge devices 203-C+1, 203-C+2, 203-D. The group 222-5 comprises edge devices 203-D+1, 203-D+2, 203-E. The group 222-M comprises edge devices 203-F+1, 203-F+2, 203-G. The edge devices 203 are shown as including tablets, drones, cellular phones, mobile computing devices, and virtual reality (VR) headsets. The edge devices 203 can comprise different types of edge devices other than those shown herein.

The central server 202 can provide the initial ANN model 205-2 by providing portions of the ANN model 205-2 to the groups 222. For instance, the central server 202 can provide a first portion of the initial ANN model 205-2 to the group 222-1, a section portion of the initial ANN model 205-2 to the group 222-2, a third portion of the initial ANN model 205-2 to the group 222-3, a fourth portion of the initial ANN model 205-2 to the group 222-4, a fifth portion of the initial ANN model 205-2 to the group 222-5, and an Mth portion of the initial ANN model 205-2 to the group 222-M.

In various instances, a portion of an ANN model can include a layer of the ANN model. For instance, an input layer of the ANN model can comprise a first portion of the ANN model. The input layer of the ANN model can comprise multiple nodes and corresponding weights, biases, and/or activation functions. The input node depicted in the initial ANN model 205-2 and the trained ANN model 205-1 can represent a layer and can represent multiple nodes.

In various instances, the second portion, the third portion, the fourth portion, and the fifth portion can comprise a single layer or can each be a separate layer of the initial ANN model 205-2. The Mth portion of the initial ANN model 205-2 can comprise an output layer.

Providing a portion of an ANN model to a group of edge devices can include providing a different instance of the same portion of the ANN model to each of the edge devices in the group. For example, providing the first portion of the initial ANN model 205-2 to the group 222-1 can include providing the first portion to the edge device 203-1, the edge device 203-2, and the edge device 203-A, such that each of the edge devices 203-1, 203-2, 203-A receives an instance of the first portion of the initial ANN model 205-2. The central server 202 can also provide training data to the group 222-1 by providing a different instance of the training data to each of the edge devices 203-1, 203-2, 203-A, in the group 222-1. The central server 202 can provide the initial ANN model 205-2 to the groups concurrently and can provide the portions of the initial ANN model 205-2 to each of the edge devices 203 concurrently. As used herein, data can be provided concurrently by providing said data to multiple devices at relatively the same time. Data can be processed concurrently by processing the data at relatively the same time.

Each of the edge devices 203 in a group can process the training data or the activation signals provided by the central server 202. For example, the edge devices 203-1, 203-2, 203-A in group 222-1 can process the training data concurrently. Each of the edge devices 203-1, 203-2, 203-A can process different instances of the same training data concurrently using different instances of the same initial ANN model 205-2. Due to hardware differences, each of the edge devices 203-1, 203-2, 203-A can generate different activation signals. The output of each of the edge devices 203-1, 203-2, 203-A can have a same dimension. The output of the edge devices 203 can be referred to as activation signals. As used herein, activation signals describe signals that are generated using the activation function of the nodes of the ANN model.

The activation signals generated by the edge devices 203-1, 203-2, 203-A can be provided to the central server 202 or the other edge devices of the groups 222-2, 222-3, 222-4, and 222-5. For instance, the central server 202 can receive the activation signals from the edge devices 203-1, 203-2, 203-A. The central server 202 can aggregate the activation signals received from the edge devices 203-1, 203-2, 203-A.

Aggregating the activation signals can include processing multiple sets of activation signals to generate a single set of activation signals. Each of the activation signals provided by an edge device can comprise a set of activation signals. For instance, the activation signals provided by the edge device 203-1 can be a first set of activation signals, the activation signals provided by the edge device 203-2 can be a second set of activation signals, and the activation signals provided by the edge device 203-A can be an Ath set of activation signals. The central server 202 can process the first set of activation signals, the second set of activation signals, and the Ath set of activation signals to generate a single set of activation signals. The processing of the activation signals can include the averaging of the activation signals, computing the medium of the activation signals, summing the activation signals, and/or any other operations that can be performed to process the activation signals. Averaging the activation signals can include averaging a first number of activation signals of the first set of activation signals with a first number of activation signals of the other sets of activation signals, and averaging an Ath number of activation signals of the first set of activation signals with an Ath number of activation signals of the other sets of activation signals.

The central server 202 can provide the single set of activation signals to the edge devices in the groups 222-2, 222-3, 222-4, 222-5 concurrently. Different instances of a same set of activation signals can be provided to each of the edge devices of the groups 222-2, 222-3, 222-4, 222-5. Each of the edge devices of the groups 222-2, 222-3, 222-4, 222-5 can process the activation signals concurrently to generate additional activation signals. The additional activation signals can be provided to the central server 202. The central server can aggregate the additional activation signals to generate a single set of additional activation singles corresponding to each of the groups 222-2, 222-3, 222-4, 222-5.

The central server 202 can provide a first set of additional activation signals generated by edge devices of the group 222-2 to the edge devices of the group 222-M, a second set of additional activation signals generated by the edge devices of the group 222-3 to the edge devices of the group 222-M, a third set of additional activation signals generated by the edge devices of the group 222-4 to the edge devices of the group 222-M, a fourth set of additional activation signals generated by the edge devices of the group 222-5 to the edge devices of the group 222-M.

The edge devices of the group 222-M can process the activation signals received and can generate a number of outputs, each edge device generating a single output. The outputs can be provided to the central server 202. The central server 202 can aggregate the outputs to generate a single output. The central server 202 can compare the single output to an expected output to generate the loss calculation 224. The central server 202 can utilize the loss calculation 224 to cause the edge devices 203 to update their corresponding weights. The updated weights can be provided from the edge devices 203 to the central server 202.

The central server 202 can aggregate the updated weights to generate a trained ANN model 205-1. For example, the central server 202 can aggregate the weights receive from the edge devices of the group 222-1 to generate a single set of weights for the first portion of the trained ANN model 205-1, can aggregate the weights received from the edge devices of the group 222-2 to generate a single set of weights for the second portion of the trained ANN model 205-1, can aggregate the weights received from the edge devices of the group 222-3 to generate a third set of weights for the third portion of the trained ANN model 205-1, can aggregate the weights received from the edge devices of the group 222-4 to generate a fourth set of weights for the fourth portion of the trained ANN model 205-1, can aggregate the weights received from the edge devices of the group 222-5 to generate a fifth set of weights for the fifth portion of the trained ANN model 205-1, can aggregate the weights received from the edge devices of the group 222-M to generate a Mth set of weights for the Mth portion of the trained ANN model 205-1.

The central server 202 can utilize the aggerated weights to generate the trained ANN model 205-1 which can be used as a final ANN model or which can be saved as the initial ANN model 205-2 if further training is needed. The creation of the trained ANN model 205-1 can constitute a first loop of the training instructions 110 of FIG. 1. Each time the trained ANN model 205-1 is stored as the initial ANN model 205-2 a next loop of the training instructions can initiate.

In various instances, the central server 202 can be configured to distribute the activation signals from one group to multiple groups, from multiple groups to one group, from one group to one group, and/or from multiple groups to multiple groups. The central server 202 can also provide instructions to the groups 222 to cause the groups to distribute the activation signals among themselves without first providing the activation signals to the central server 202.

In various examples, the edge devices 203 can be grouped based on characteristics of the edge devices 203 which can be beneficial for the training of the initial ANN model 205-2. For example, edge devices 203 in a geographical location can be grouped together, or edge devices 203 of different computing capabilities can be grouped together. Grouping edge devices 203 of different computing capabilities can provide for diverse sets of activation signals which can contribute to confidence in the training of the initial ANN model 205-2.

In various instances, the input data, the activation signals provided by the edge devices 203 to the central server 202, and the activation signals provided by the central server 202 to the edge devices 203 can comprise matrices. For example, the input data can be a first matrix, activation signals provided from each of the edge devices of the group 222-1 to the central server 202 can be a second set of matrices, and the activation signals provided from the central server 202 to the edge devices of the group 222-2 can be a third matrix. Each of the matrices of the second set of matrices can have a same dimension. The third matrix can be provided to each of the edge devices of the groups 222-2, 222-3, 222-4, 222-5.

The edge devices 203 can be grouped based on the edge devices' ability to receive matrices having a particular dimension and based on the edge devices' ability to process the received matrices utilizing a corresponding portion of the initial ANN model. For example, the edge devices 203-F+1, 203-F+2, 203-G can be grouped based on their ability to receive the activation signals from the groups 222-2, 222-3, 222-4, 222-5 and based on their ability to process the received activation signals to generate an output. The edge device 203-E may not be included in the group 222-M given that the edge devices 203-E may be incapable of processing the activation signals received from the groups 222-2, 222-3, 222-4, 222-5 in a baseline amount of time. For example, the activation signals received from the groups 222-2, 222-3, 222-4, 222-5 may not be processed concurrently by the edge devices 203-F+1, 203-F+2, 203-G if the edge device 203-E is included in the group 222-M given that the edge device 203-E may be incapable of processing the activation signals concurrently with the edge devices 203-F+1, 203-F+2, 203-G. The edge device 203-E may be incapable of processing the activation signals concurrently with the edge devices 203-F+1, 203-F+2, . . . , 203-G given the processing capabilities of the edge device 203-E and the edge devices 203-F+1, 203-F+2, 203-G.

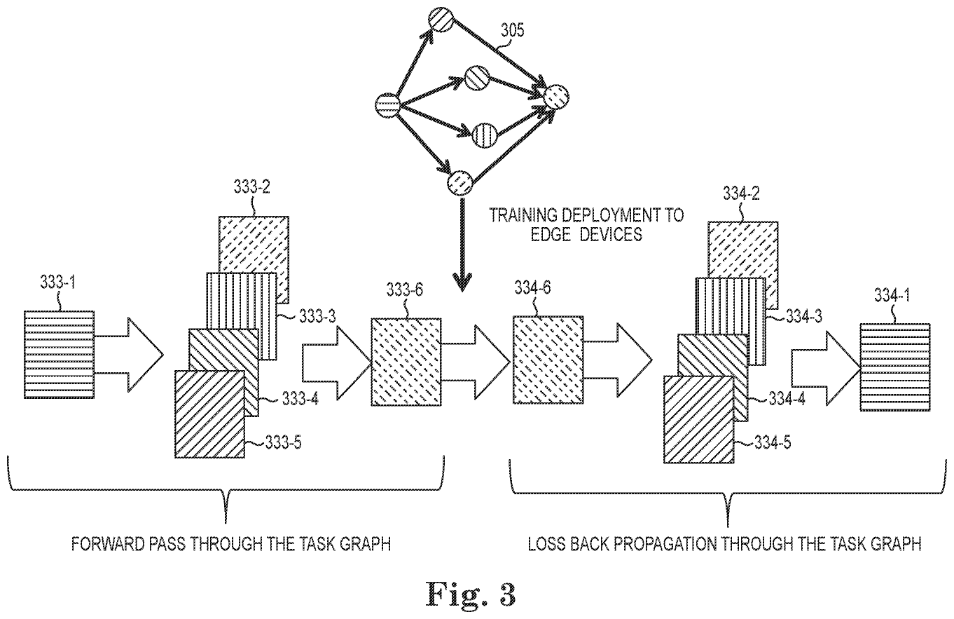

FIG. 3 illustrates a block diagram for training an ANN model 305 in accordance with some embodiments of the present disclosure. FIG. 3 illustrates a forward pass (e.g., forward propagation) of the initial ANN model and a loss back propagation (e.g., backward propagation) through the initial ANN model.

In various instances, the training of the ANN model 305 can be divided into tasks that comprise a task graph. The forward pass can include the tasks 333-1, 333-2, 333-3, 333-4, 333-5, 333-6, referred to as tasks 333. Each of the tasks 333 can be performed by processing input data and activation signals utilizing an initial ANN model 305 and multiple edge devices.

An output can be generated responsive to performing the tasks 333. The central server can perform a loss calculation utilizing the output of the ANN model 305. The loss calculation (e.g., loss function) can be used to measure how well the ANN model 305 models the training data. Training minimizes a loss between the output of the ANN model 305 and the target outputs. The hyperparameters (e.g., weights, biases, and/or activation functions) can be adjusted to minimize the average loss between the output of the ANN model 305 and the target output. The hyperparameters of the ANN model 305 can be adjusted by the edge devices.

The loss function can be any one of a number of loss functions. For example, the loss function can be a mean square error loss function or a mean absolute error loss function, among other possible loss functions. Back propagation includes computing the gradient of the loss function with respect to the weights of the ANN model 305 for a single input-output example. Gradient algorithms can be used for training multilayer ANN models, updating weights to minimize loss, for example, using gradient descent or variants such as stochastic gradient descent. Back propagation works by computing the gradient of the loss function with respect to each weight by the chain rule. The chain rule can describe the computing of the gradient one layer at a time.

In various instances, the central server can compute the loss function. The central server can also compute the gradient descent of the loss function with respect to the weights of the ANN model 305. The central server has access to the weights because the central server provided the weights to the edge devices previously. The central server can provide the updated weights to the edge devices. The edge devices can update their corresponding portions of the ANN model 305 using the provided weights. The server can also cause the edge devices to calculate their own gradient descent of the loss function with respect to their corresponding weights. For example, the central server can provide the loss function and the edge devices can calculate the gradient descent. The edge devices can update their corresponding weights and can provide the updated weights to the central server.

The task of calculating the gradient descent of the loss function can include tasks 334-1, 334-2, 334-3, 334-4, 334-5, 334-6. The tasks can be performed by the corresponding edge devices of the corresponding groups and/or the central server.

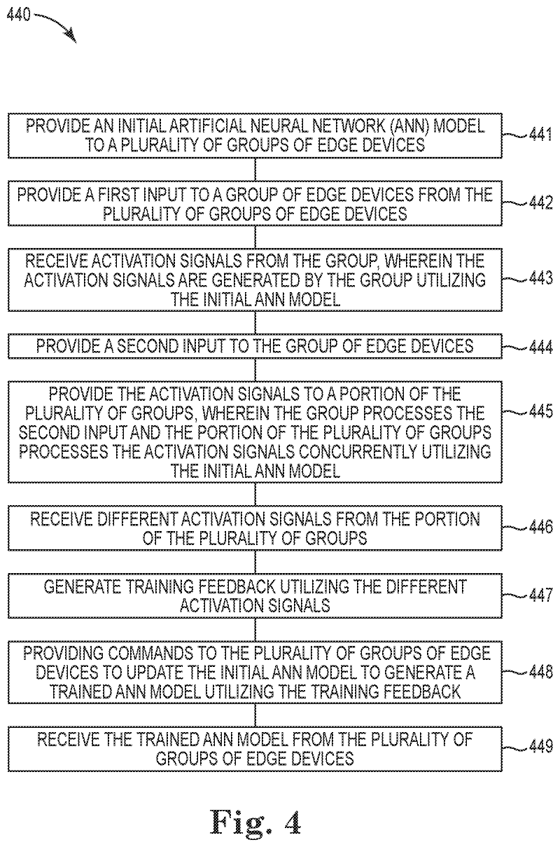

FIG. 4 is a flow diagram corresponding to a method 440 for training an artificial neural network in accordance with some embodiments of the present disclosure. The method 440 may be performed, in some examples, using a computing system such as those described with respect to FIG. 1. The method 440 can include the training of an ANN model.

At 441, a central server can provide an initial ANN model to a plurality of groups of edge devices. At 442, a first input can be provided to a group of edge devices from the plurality of groups of edge devices. At 443, the central server can receive activation signals from the group. The activation signals can be generated by the group utilizing the initial ANN model. At 444, the central server can provide a second input to the group of edge devices. At 445, the central server can further provide the activation signals to a portion of the plurality of groups. The group can process the second input and the portion of the plurality of groups can process the activation signals concurrently utilizing the initial ANN model. Different groups can process input signals or activation signals concurrently because the different groups process the input signals and the activation signals independent from one another. Processing the second input and the activation signals concurrently can increase efficiency of the use of the edge device and can expedite the training of the ANN model.

At 446, the central server can receive different activation signals from the portion of the plurality of groups. At 447, the central server can generate training feedback utilizing the different activation signals. At 448, the central server can also provide commands to the plurality of groups of edge devices to update the initial ANN model to generate a trained ANN model utilizing the training feedback. At 449, the central server can receive the trained ANN model from the plurality of groups of edge devices.

In various instances, the central server can generate the training feedback utilizing the different propagation signals and the activation signals. The second input and the different activation signals can be processed by the plurality of groups concurrently.

A central server can divide a plurality of edge devices into the plurality of groups based on computing capabilities of the plurality of edge devices. For example, edge devices with greater computing capabilities than different devices can be grouped together. In various instances, providing the activation signals further comprises providing matrices representing the activation signals, wherein the matrices are fixed. The matrices are fixed given that the dimensions of the matrices do not change. The matrices can be fixed because each of the edge devices in a group that provide the matrices are configured similarly to provide matrices having same dimensions.

A processing device of a central server can provide an initial ANN model to a plurality of groups of edge devices. The processing device can provide the initial ANN model via a wireless network or a physical network. The central server can provide an input to a group of edge devices from the plurality of groups of edge devices. The input can be training data. Responsive to providing the input, activation signals can be received from a first portion of the plurality of groups. The activation signals can be provided to a second portion of the plurality of groups. Commands can also be provided to the plurality of groups of edge devices to train the initial ANN model to generate a trained ANN model based on training feedback generated using different activation signals received from the second portion of the plurality of groups. The central server can also receive the trained ANN model from the plurality of groups of edge devices.

The central server can generate the training feedback by performing a loss calculation using the activation signals and the different activation signals. For example, the activation signals can be used to generate an output for the initial ANN model. The output can be used to perform the loss calculation such that the loss calculation uses the activation signals and the different activation signals indirectly.

The central server can also provide the initial ANN model to the plurality of groups by providing a different portion of the initial ANN model to each of the plurality of groups of edge devices. The different portion of the initial ANN model provided to a group from the plurality of groups can be provided to each of the edge devices in the group. Each of the different portions of the initial ANN model can comprise a plurality of layers of the initial ANN model or a single layer of the initial ANN model.

The central server configured to receive the trained ANN model can also receive a plurality of same layers of the trained ANN model from each of the plurality of groups of edge devices. For example, each edge device in a group can provide a same layer of the trained ANN model. The various instances of the same layer provided by the edge devices of a group can be aggregated to generate a single layer. The central server can perform weight aggregation on each of the plurality of same layers received from each of the plurality of groups to generate a plurality of layers that comprise the trained ANN model. For instance, a quantity of weights from each edge device in each of the plurality of groups of edge devices can be received by the central server. The central server can aggregate the quantity of weights received from edge devices in each of the plurality of groups to generate a layer from the plurality of layers, for each of the plurality of groups, of the trained ANN model.

Providing the activation signal to the second portion of the plurality of groups can include providing a different instance of the activation signal to each edge device in the second portion of the plurality of groups. Each edge device in a group or multiple groups can receive a same number of activation signals in the form of a matrices such that each edge device in the group or multiple groups receives a same matrix.

The central server can provide activation signals to the edge devices by generate a single set of the activation signals prior to providing the activation signals to the second portion. The activation signals can comprise multiple sets, each set corresponding to a different memory device from the first portion of the plurality of groups of memory devices.

In various examples, an edge device can receive a portion of an initial ANN model from a central server. The edge device can be part of a first group of edge devices that receive the portion of the initial ANN model. The edge device in the first group can receive the portion of the initial ANN model concurrently. The edge device can receive first activation signals from the central server. The first activation signals can be generated by a second group of edge devices. The first activation signals can be forward propagation signals from the second group of edge devices.

The edge device can process the first activation signals utilizing the portion of the initial ANN model to generate second activation signals. The edge device can provide the second activation signals to the central server for providing to a third group of edge devices. In various examples, the edge device can provide the second activation signals directly to the third group of edge devices.

The edge device can receive feedback from the central server. The feedback can be at least partially based on the second activation signals. The feedback can be generated by the central server. The edge device can update weights of the portion of the initial ANN model utilizing the feedback to generate an updated portion of the ANN model. The edge device can provide the updated portion of the ANN model to the central server.

The edge device can also process the first activation signals utilizing the portion of the initial ANN model to generate the second activation signals, where each edge device of the first group of edge devices processes the first activation signals concurrently. The edge device can also receive the first activation signal concurrently with a receipt of the first activation signals by the edge devices of the first group.

The edge device can provide the updated portion of the ANN model concurrently with a providing of different updated portion of the ANN model by the edge devices of the first group. The edge devices of the first group can provide their corresponding updated portions of the ANN model.

In various instances, the feedback can be based, at least partially on the first activation signals and the second activation signals. The feedback can also be based on an output that is generated utilizing the second activation signal and/or the first activation signals. The output can be generated by a different group of edge devices.

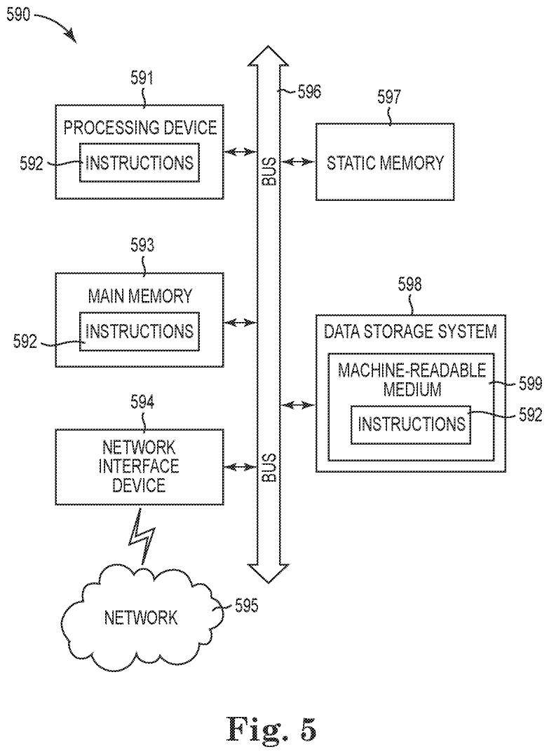

FIG. 5 is a block diagram of an example computer system 590 in which embodiments of the present disclosure may operate. For example, FIG. 5 illustrates an example machine of a computer system 590 within which a set of instructions, for causing the machine to perform any one or more of the methodologies discussed herein, can be executed. In some embodiments, the computer system 590 can correspond to a host system that includes, is coupled to, or utilizes a memory sub-system (e.g., the memory sub-systems 111-1, 111-2, 111-N+1 of FIG. 1). The computer system 590 can be used to perform the operations described herein (e.g., to perform operations corresponding to the processors 104-1, 104-2, 104N+1 of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device (e.g., processor) 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

The processing device 591 represents one or more general-purpose processing devices such as a microprocessor, a central processing unit, or the like. More particularly, the processing device 591 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media. The machine-readable storage medium 599, data storage system 598, and/or main memory 593 can correspond to the memory sub-systems 111-1, 111-2, 111-N+1 of FIG. 1.

In one embodiment, the instructions 592 include instructions to implement functionality corresponding to mirroring data to a virtual environment (e.g., using processors 104-1, 104-2, 104-N+1 of FIG. 1). While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus comprising:
a processing device configured to:
provide an initial artificial neural network (ANN) model to a plurality of groups of edge devices;
provide an input to a group of edge devices from the plurality of groups of edge devices;
responsive to providing the input, receive activation signals from a first portion of the plurality of groups;
provide the activation signals to a second portion of the plurality of groups;
provide commands to the plurality of groups of edge devices to train the initial ANN model to generate a trained ANN model based on training feedback generated using different activation signals received from the second portion of the plurality of groups; and
receive the trained ANN model from the plurality of groups of edge devices.

2. The apparatus of claim 1, wherein the processing device is further configured to generate the training feedback by performing a loss calculation using the activation signals and the different activation signals.

3. The apparatus of claim 1, wherein the processing device is further configured to provide the initial ANN model to the plurality of groups by providing a different portion of the initial ANN model to each of the plurality of groups of edge devices.

4. The apparatus of claim 3, wherein each of the different portions of the initial ANN model comprises a plurality of layers of the initial ANN model.

5. The apparatus of claim 1, wherein the processing device is further configured to provide the initial ANN model to the plurality of groups by providing a different layer of the initial ANN model to each of the plurality of groups of edge devices.

6. The apparatus of claim 1, wherein the processing device configured to receive the trained ANN model is further configured to receive a plurality of same layers of the trained ANN model from each of the plurality of groups of edge devices.

7. The apparatus of claim 6, wherein the processing device is further configured to perform weight aggregation on each of the plurality of same layers received from each of the plurality of groups to generate a plurality of layers that comprise the trained ANN model.

8. The apparatus of claim 6, wherein the processing device is further configured to:
receive a quantity of weights from each edge device in each of the plurality of groups of edge devices; and
aggregate the quantity of weights received from edge devices in each of the plurality of groups to generate a layer from the plurality of layers, for each of the plurality of groups, of the trained ANN model.

9. The apparatus of claim 1, wherein the processing device configured to provide the activation signal to the second portion of the plurality of groups is further configured to provide a different instance of the activation signal to each edge device in the second portion of the plurality of groups.

10. The apparatus of claim 1, wherein the processing device is further configured to generate a single set of the activation signals prior to providing the activation signals to the second portion.

11. The apparatus of claim 10, wherein the activation signals comprise multiple sets, each set corresponding to a different memory device from the first portion of the plurality of groups of memory devices.

12. An apparatus comprising:
a processing device configured to:
receive a portion of an initial artificial neural network (ANN) model from a central server, wherein the apparatus is part of a first group of edge devices that receive the portion of the initial ANN model;
receive first activation signals from the central server, wherein the first activation signals are generated by a second group of edge devices;
process the first activation signals utilizing the portion of the initial ANN model to generate second activation signals;
provide the second activation signals to the central server for providing to a third group of edge devices;
receive feedback from the central server, wherein the feedback is at least partially based on the second activation signals;
update weights of the portion of the initial ANN model utilizing the feedback to generate an updated portion of the ANN model; and
provide the updated portion of the ANN model to the central server.

13. The apparatus of claim 12, wherein the processing device is further configured to process the first activation signals utilizing the portion of the initial ANN model to generate the second activation signals, wherein each edge device in first group of edge devices processes the first activation signals concurrently.

14. The apparatus of claim 13, wherein the processing device is configured to receive the first activation signals concurrently with a receipt of the first activation signals by the edge devices of the first group.

15. The apparatus of claim 12, wherein the processing device configured to provide the updated portion of the ANN model is further configured to provide the updated portion of the ANN model concurrently with a providing of different updated portion of the ANN model by the edge devices of the first group.

16. The apparatus of claim 12, wherein the feedback is based, at least partially, on the first activation signals and the second activation signals.

17. The apparatus of claim 12, wherein the feedback is based on an output that is generated utilizing the second activation signals.

18. The apparatus of claim 17, wherein the output is generated by a different group of edge devices.

19. A method comprising:
providing an initial artificial neural network (ANN) model to a plurality of groups of edge devices;
providing a first input to a group of edge devices from the plurality of groups of edge devices;
receiving activation signals from the group, wherein the activation signals are generated by the group utilizing the initial ANN model;
providing a second input to the group of edge devices;
providing the activation signals to a portion of the plurality of groups, wherein the group processes the second input and the portion of the plurality of groups processes the activation signals concurrently utilizing the initial ANN model;
receiving different activation signals from the portion of the plurality of groups;
generating training feedback utilizing the different activation signals;
providing commands to the plurality of groups of edge devices to update the initial ANN model to generate a trained ANN model utilizing the training feedback; and
receiving the trained ANN model from the plurality of groups of edge devices.

20. The method of claim 19, further comprising generating the training feedback utilizing the different propagation signals and the activation signals.

21. The method of claim 19, wherein the second input and the different activation signals are processed by the plurality of groups concurrently.

22. The method of claim 19, further comprising dividing a plurality of edge devices into the plurality of groups based on computing capabilities of the plurality of edge devices.

23. The method of claim 19, wherein providing the activation signals further comprises providing matrices representing the activation signals, wherein the matrices are fixed.
